(19) United States
(12) Patent Application Publication
(10) Pub. No.: US 2017/0049115 A1
(43) Pub. Date: Feb. 23, 2017

(54) IMPROVED COOKED DOUGH FOR BAKED GOODS SUITABLE FOR BEING DEFROSTED

(71) Applicant: Sergio David HERRERA, Buenos Aires (AR)

(72) Inventor: Sergio David HERRERA, Buenos Aires (AR)

(21) Appl. No.: 15/117,970

(22) PCT Filed: Feb. 9, 2015
(86) PCT No.: PCT/PE15/00001

§ 371 Date: Oct. 27, 2016

(30) Foreign Application Priority Data
Feb. 11, 2014 (AR) 20140100424

(51) Int. Cl. A21D 13/00; A21D 6/00

(52) U.S. Cl. CPC A21D 13/0061; A21D 6/001; A21D 13/0009

(57) ABSTRACT

The invention comprises a process and a product which, by using conventional and basic equipment and without requiring any particular system or equipment for defrosting and fermentation, achieves an optimum-quality product in relation to which the consumer cannot determine whether it is fresh or the result of a defrosting process. Thus, a bread dough is achieved which is suitable for elaborating medialunas, vigilantes [both are croissant-type products], and all types of bread, of different shapes and sizes, and the post-baking quality of which is highly advantageous in terms of flavor, texture, aspect and volume, these characteristics not being altered after defrosting. The type of oven for baking the dough can be: brick-built, rotating, tunnel, convection or pastry ovens of any dimensions, and no special installations for defrosting and fermentation are required.

### TECHNICAL FIELD OF INVENTION

The invention comprises a process and a product which, by using conventional and basic equipment and without requiring any particular system or equipment for defrosting and fermentation, achieves an optimum quality product in relation to which the consumer cannot determine whether it is fresh or the result of a defrosting process

Thus, a bread dough is achieved which is suitable for elaborating medialunas, vigilantes [both are croissant-type products], and all types of bread, of different shapes and sizes, and the post-baking quality of which is highly advantageous in terms of flavor, texture, aspect and volume, these characteristics not being altered after defrosting.

The type of oven for baking the dough can be: brick-built, rotating, tunnel, convection or pastry ovens of any dimensions; no special installations for defrosting and fermentation are required

The bread dough achieved has a uniform structure and multiple applications; it is elaborated with relatively hard wheat flour and contains yeast and a butter mixture (butter+margarine); the dough is given the desired shape, placed in dough pans and left to rise (for the corresponding proofing period), and after this, it is baked.

### SOLUTIONS TO PROBLEMS AND PRIOR ART

The invention comprises a process for producing a bread dough suitable for elaborating medialunas, vigilantes, and other croissant-type products, pizza, tapa de empanada [round flat pieces of dough], calzone [folded pizza], and all other types of dough, of different shapes and sizes, which can be cooked, frozen and defrosted without losing its original characteristics and in relation to which the consumer cannot determine whether it is fresh or the result of a defrosting process

These farinaceous products achieve a highly advantageous post-baking quality in terms of flavor, texture, aspect and volume.

It is known that air hardens this kind of products by causing starch retrogradation. That is, when the dough loses moisture due to evaporation, the starch molecules reform and harden. Freezers may prevent bread from staling for a few months; however, when the product is defrosted, it loses its original properties of flavor, texture, aspect and volume. This happens because when microwave is used, the water contained in the product is heated, thereby, heating the rest of the piece and getting it moist; the product ends up cooked rather than toasted, and as a consequence, its consistence becomes “rubbery”.

Similarly, when using ovens for defrosting, the original quality is lost; changes occur in terms of aspect, texture (it becomes harder) and flavor.

To date, there is no process or product which may enable defrosting without changing the original quality of the product, and in relation to which the consumer cannot determine whether it is fresh or the result of a defrosting process.

The invention comprises a process and a product which, by using conventional and basic equipment and without requiring any particular equipment for defrosting and fermentation, achieves an optimum quality product in relation to which the consumer cannot determine whether it is fresh or the result of a defrosting process because it preserves its volume, moisture, scent and all organoleptic properties

At present, in order to solve this problem, some preservatives are added which directly affect raw materials and ruin the natural elements; therefore, this does not constitute a satisfactory solution.

### DESCRIPTION OF THE INVENTION

The dough contains wheat flour and yeast as main ingredients, and other raw materials such as salt, sugar, bee honey, malt extract, butter, margarine, water and similar materials.

Since moisture content is 80%, the dough achieves a silky smooth texture. After kneading, the dough shall be allowed to rest at the appropriate temperature (lower than 5° C.) in order to avoid undesired effects in the process.

Following this, the mixture of butter and margarine is incorporated to said dough, and at this first stage, the dough shall be folded in thirds (or applied the simple fold). It shall be preserved in plastic wrap and refrigerated for a minimum of 3 or 4 hours, always keeping temperature lower than 5° C. Once this stage is completed, the (simple) folding procedure shall be repeated by using the necessary utensils (rolling pin or dough rolling machine) and the dough will be wrapped in plastic wrap again and appropriately refrigerated for at least 24 hours. During this time, the raw materials and leavening agents interact and soften the dough to the necessary texture; once this period is completed, the third and last folding is performed. Once the folding process is finished, the dough will end up layered or laminated, with its specific texture and ready to be used, cut, rolled into balls, and allowed to proof in the desired size and shape.

The dough can be either left to proof for posterior baking, or taken to cooling units or fridge a temperature lower than 5° C. so as not to alter the components, and bake it later, preferably within 48 hours after the dough has risen, because beyond that time, the dough components start altering and deteriorating in a slow, gradual but constant fashion, thereby leading to an unsatisfactory product. In order to avoid this, all mentioned requirements shall be met.

Once the dough is taken out of the cooling unit or fridge (where it has been placed at the appropriate temperature and taking all necessary precautions), the qualified laborer may choose to brush the dough with egg, and then, he/she shall let it rest at controlled room temperature (between 20° and 40° C.) in order to achieve a constant and unaltered leavening effect before it is ready for baking.

### Baking

The dough shall be baked—continuously but not constantly—at a temperature between 160° and 190° of dry heat and no water vapor so that, during a period of 10-17 minutes, the dough may only receive radiant heat at all different temperature ranges, which constitutes the key of this invention. The qualified person determines the time when the dough is ready. Once the baking process is completed, the dough is taken out from the oven for final brush (glaze, coat) with syrup specially prepared for this invention.

### Composition and Ingredients

In order to develop this invention, the following composition of ingredients is required:

Butter Flavor: 50-70 cc.

Vanilla Flavor: 110-125 cc

Yeast: 150-200 g.

Malt: 180-200 g.

Salt: 180-200 g

Honey: 200-250 g.

Butter: 3.5-4 kg

Water: 4-4.5 liters (though it can be replaced by milk, in part or entirely, water is preferred)

Sugar: 700

### Syrup

It is the key element in this invention; this syrup is specially prepared for moistening the inner part of the dough and protecting the outer part through a thin coat that provides the dough with its particular flavor, texture, finishing touch and aspect. Once the dough is applied a brush/coat of this syrup, it shall be left to rest at room temperature for the necessary time, and within 3 hours after final cooling, it shall be taken to freezer.

This special syrup, also elaborated with completely natural ingredients, is specifically prepared for this invention. It is a reduction made of water, citrus fruits and flavoring, boiled until it gets the density required for penetrating through the baked dough, as well as for serving as the outer protective coat which provides the product with its characteristic texture and subtle scent

In order to elaborate the syrup for this invention, the following composition of ingredients is required:

Lemon Juice: 300-500 cc

Sugar: 5 kg (approx.)

Water: 10 liters (approx.)

### Freezing

The process of freezing shall be performed with the appropriate equipment (freezer, cool units) set at a temperature lower than −20° C., using the corresponding bags into cardboard boxes, which help protect the product when in preparation for baking.

The product can be kept in the freezer for up to 6 months at −20° C., at constant temperature, that is, without changes, for as long as the dough piece is at rest, until it is taken out for consumption.

### Defrosting

The process of defrosting implies a direct transfer from freezer to microwave; no other intermediate step or process is required. The frozen piece of dough shall be microwaved for a few seconds directly in reheat mode at maximum temperature, there not being any other prior defrosting step.

Once the piece has been reheated, depending on its size, shape, volume and weight, another brush or coat of syrup will be applied for defining the piece's final touch and presentation. The pieces are ready to be consumed, or filled with cream, candy, jams, jelly, and all other kinds of filling, or given any kind of finish or decoration—this being possible at the post-baking stage as well as at the pre-baking stage

### SUMMARY

The invention comprises a process and a product which, by using conventional and basic equipment and without requiring any particular system or equipment for defrosting and fermentation, achieves an optimum-quality product in relation to which the consumer cannot determine whether it is fresh or the result of a defrosting process.

Thus, a bread dough is achieved which is suitable for elaborating medialunas, vigilantes [both are croissant-type products], and all types of bread, of different shapes and sizes, and the post-baking quality of which is highly advantageous in terms of flavor, texture, aspect and volume, these characteristics not being altered after defrosting.

The type of oven for cooking the dough can be: brick-built, rotating, tunnel, convection or pastry ovens of any dimensions, and no special installations for defrosting and fermentation are required.

Having described and determined the nature and extent of this invention and the appropriate specifications for developing said invention, what is claim is:

1. An improved baked dough for bakery products, suitable for being defrosted wherein the quality of the defrosted product is exactly the same as the fresh product

2. The improved baked dough for bakery products of claim 1, wherein the dough moisture percentage is 80%.

3. The improved baked dough for baked goods of claim 1, wherein the improvement comprises a mixture made of the following ingredients:
Butter Flavor: 50-70 cc.
Vanilla Flavor: 110-125 cc
Yeast: 150-200 g.
Malt: 180-200 g.
Salt: 180-200 g
Honey: 200-250 g.
Butter: 3.5-4 kg
Water: 4-4.5 liters (though it can be replaced by milk—in part or entirely—, water is preferred)
Sugar: 700-800 g

4. The improved baked dough for bakery products of claim 1, wherein the improvement comprises preservation in plastic wrap and cooling for a minimum of 3 or 4 hours, always keeping temperature lower than 5° C.

5. The improved baked dough for bakery products of claim 1, wherein the improvement comprises folding and preserving in plastic wraps for a second time, and taking to controlled refrigeration again, this time for no less than 24 hours.

6. The improved baked dough for bakery products of claim 1, wherein immediate fermentation is achieved for posterior baking or refrigeration, at a controlled temperature lower than 5° C.

7. The improved baked dough for bakery products of claim 1, wherein, once the dough has been allowed to rest at controlled room temperature between 20° and 40° C., it achieves a leavening effect and follows a constant and unaltered process until it is ready for baking at a continuous but not constant temperature between 160° and 190° of dry heat and no water vapor so that, during a period of 10-17 minutes, the dough may only receive radiant heat, undergoing all different temperature ranges.

8. The improved baked dough for bakery products of claim 1, wherein, once the dough is baked, it is brushed or coated with syrup containing the following ingredients:
Lemon Juice: 300-500 cc
Sugar: 5 kg (approx.)
Water: 10 liters (approx.)

9. The improved baked dough for bakery products of claim 1, wherein the process of defrosting implies a direct transfer—no other intermediate step or process being required—from freezer to microwave, where the dough is placed for a few seconds, in reheat mode at maximum temperature, there not being any other prior defrosting step.
